(19) United States
(12) Patent Application Publication
(10) Pub. No.: US 2003/0018486 A1
(43) Pub. Date: Jan. 23, 2003

(54) Consistency validation for complex classification rules

(76) Inventors: Jacob Feldman, Edison, NJ (US); Alexander Korolov, Cliffside Park, NJ (US); Semen Meshcheryakov, Edison, NJ (US); Stanislav Shor, Edison, NJ (US)

Correspondence Address: John P. Ward, BLAKELY, SOKOLOFF, TAYLOR & ZAFMAN LLP, Seventh FLOOR, 12400 Wilshire Boulevard, Los Angeles, CA, 90025-1026, US

(21) Appl. No.: 09/953,701

(22) Filed: Sep. 11, 2001

Related U.S. Application Data
(60) Provisional application No. 60/300,951, filed on Jun. 25, 2001.

(51) Int. Cl. G06F 17/60

(52) U.S. Cl. 705/1

(57) ABSTRACT

A method and apparatus for providing a practical solution for the generic problem of consistency validation of complex business rules is disclosed. In one embodiment, the method and apparatus is implemented with software tools.

The present application claims priority to the following provisional filed applications entitled Consistency Validation for Complex Classification Rules, filed on Aug. 16, 2001, serial no. ______; entitled Hybrid Use of Rule and Constraint Engines, filed on Jun. 25, 2001, serial no. 60/300,951; entitled Minimization of Business Rule Violations, filed on Aug. 16, serial no. ______, all of which are incorporated herein by reference.

### FIELD OF THE INVENTION

The present invention relates generally to the field of expert systems.

### BACKGROUND OF THE INVENTION

Modern rule-based technology provides the ideal architecture for implementing flexible, easy-to-maintain business rule applications, because such applications keep the rules separate from the application code. Business rules are statements of business policies and procedures that drive day-to-day business activity. Typically, the rules are presented in the form of “if <condition> then <action>”, thus allowing the users to describe a numerous and various business situations.

However, in real-world e-business applications, such as an Insurance Rating system or a Financial Loan Origination system, business rules can rarely be presented in the form of simple “if-then” statements. In particular, typical classification rules are combinations of multiple criteria, which frequently are presented as multi-column multi-row tables.

For example, the insurance driver classification rule considers all possible combinations of driver age, gender, marital status, driving experience, vehicle usage, etc. Such rules result in multi-page tables, which are difficult to create and maintain. Usually, maintenance of business rules is the responsibility of (non-technical) business specialists, and the proper software tool has to provide consistency checking of rules with a complex infrastructure, and must point users to possible inconsistencies.

### SUMMARY OF THE INVENTION

A method and apparatus for providing a practical solution for the generic problem of consistency validation of complex business rules is disclosed. In one embodiment, the method and apparatus is implemented with software tools.

### BRIEF DESCRIPTION OF THE DRAWINGS

FIG. 1 is a flow diagram showing a method for validating the consistency of business rules, according to one embodiment.

### DETAILED DESCRIPTION

In one embodiment, typical classification rules deal with one prime classification object (for example, Driver) and different combinations of its attributes (such as Age, Gender, Marital Status, Driving Experience, Vehicle Usage, Violation Points, etc.). Such classification rules usually state the proper object class for all possible combinations of its attributes.

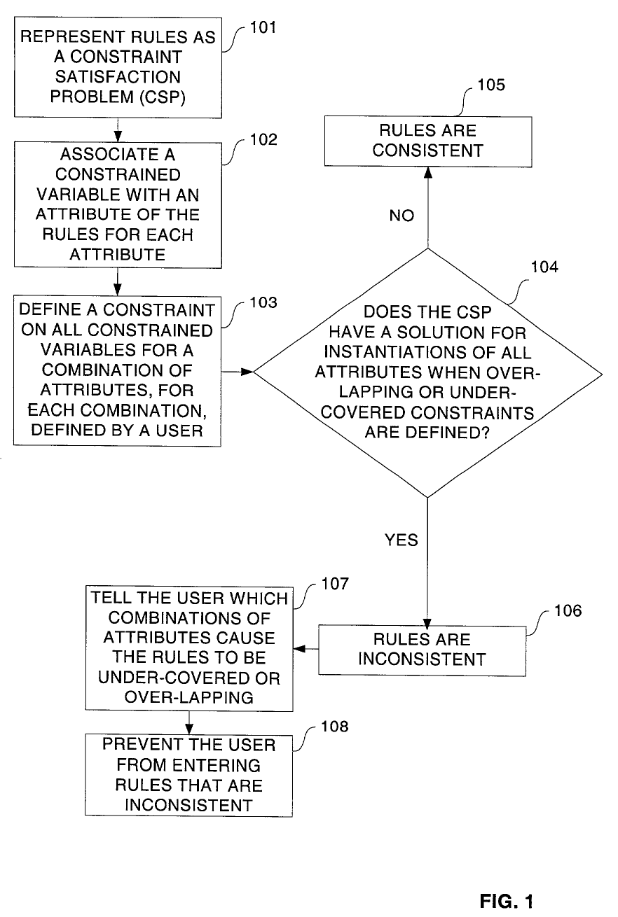

In one embodiment, as exemplified in FIG. 1, according to one embodiment, classification rules are represented as a constraint satisfaction problem (CSP), shown in process block 101. One constrained variable is associated with each attribute, shown in process block 102, and for each user-defined combination of the attributes, a constraint on these variables is defined, shown in process block 103. Thus, in one embodiment, consistency checking deals with only three possible situations:

1. Over-Lapping: The classification includes contradictory (overlapping) combinations of attribute values.

2. Under-Coverage: The classification rule does not cover all possible situations.

3. Consistency: The rule is consistent.

For example, consider the driver classification rule represented in the following table:

| | Marital | Driver | Driving | Vehicle | Violation | Driver |
|---|---|---|---|---|---|---|
| Gender | Status | Age | Experience | Usage | Points | Class |
| Male | Single | 17 | 0 | 100 | 0 | A111 |
| | | through | through | | | |
| | | 24 | 1 | | | |
| Male | Married | 17 | 0 | 100 | 0 | A112 |
| | | through | through | | | |
| | | 24 | 1 | | | |
| . . . | | | | | | |

To cover all possible combination of attributes, an actual table may consist of 20 or more pages. In one embodiment, several attributes could be unrelated to the values of other attributes. For example, if the number of violation points is too high, it results in a special driver class, independent of the driver's age or gender.

To define a constraint satisfaction problem (CSP), in one embodiment one constrained integer variable is associated with each attribute, as seen in process block 102, and as shown in this expression:

Attr(x), xε{1, N}

The number N corresponds to the number of columns in the table above. The domain of possible values has a specific size and content for each Attr(x), but without losing the generality of the definition, all values could in one embodiment be considered as integers.

Now assume that there are M different combinations of all attributes defined by the user. The number M corresponds to the number of rows in the table above. If cell (x,y) defines some values for Attr(x), a Boolean constrained expression CellExp(x,y) may in one embodiment be associated with the cell. For example, for cell (1,1) the condition like “Gender is Male” could be represented in one embodiment as

CellExp(1,1): Attr(1)==0,

where 0 corresponds “Male”.

Similarly, for cell (3,2) a condition such as, for example, “Age is 17 through 24”, could be represented in one embodiment as

CellExp(3,2): Attr(3)>=17 && Attr(3)<=24.

Each user-defined combination of attributes (the table row number “y” in this example) could be presented in one embodiment as a Boolean constrained expression

RowExp(y)=αₓCellExp(x,y),

where α is a logical “and” of all y Boolean expressions CellExp(x,y). And, finally, an integer-constrained variable may be defined, as seen in process block 103, in one embodiment as

AllRows=Σ_{y}RowExp(x,y),

To validate the consistency of the classification rule in one embodiment, the following CSP(s) could be solved:

Under-Coverage Validation: In one embodiment, with the constraint defined “AllRows==0”, an attempt is made to instantiate all Attr(x). If the CSP has a solution, it means that there is a combination of attributes for which all RowExp(y) are false. In the example given in this embodiment, it means a driver exists who cannot be classified by any defined row of attributes, and the classification rule is inconsistent (due to under-coverage). This evaluation is shown in process blocks 104 and 106 of FIG. 1.

Over-Lapping Validation: In one embodiment, with the constraint defined “AllRows>1”, an attempt is made to instantiate all Attr(x). If the CSP has a solution, it means that more than one row conditions are true. In the example given in this embodiment, it means a driver exists who could be classified by more than one row of attributes, and the classification rule is inconsistent (due to over-lapping). This evaluation is shown in process blocks 104 and 106 of FIG. 1.

The classification rule is consistent, as shown in process block 105 according to one embodiment, when the CSP has no solutions, as shown in process block 104, under the constraint “AllRows!=1”.

The proposed solution in one embodiment goes beyond the simple “consistent” or “not consistent” diagnosis, and allows to proper program to tell the user why and where the inconsistency occurs. In cases of under-coverage, the found solution points exactly to the combination of attributes not covered by the current classification rule, shown as process block 107. In cases of over-lapping, all rows with

RowExp(y)=true are over-lapping.

And finally, the same technique could be used in one embodiment for interactive creation (configuration) of the classification rules. Instead of only pointing to the inconsistency, interactive tools could automatically generate “under-covered” rows and not to allow the user to enter over-lapping rows, shown as process block 108, or warn the user that he creates an overlap, and force him to correct it.

The described approach has been implemented in one embodiment for Auto Insurance Rating rules using Exigen Rules™ and Exigen Constrainer™.

It will be clear to the person skilled in the art, that besides insurances, other applications of the described embodiments exist, such as, including but not limited to, financial services in general, governmental agencies, resource planning situations in transport and distribution, etc.

The processes and embodiments as described above can be stored on a machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
providing for association of a constrained variable with an attribute of rules; and
providing for definition of a constraint on constrained variables for a combination of attributes defined by a user.

2. The method of claim 1, wherein the rules are consistent only if a constraint satisfaction problem has no solutions under over-lapping and under-coverage constraints.

3. The method of claim 1, wherein the rules are inconsistent if a constraint satisfaction problem has a solution by instantiations of all attributes when over-lapping or under-coverage constraints are defined.

4. The method of claim 1, further comprising providing for telling a user which combinations of attributes cause the rules to be under-covered or over-lapping.

5. The method of claim 1, further comprising providing for preventing a user from entering rules that are inconsistent.

6. A machine-readable medium that provides instructions which, when executed by a machine, cause the machine to perform operations comprising:
associating a constrained variable with an attribute of rules; and
defining a constraint on constrained variables for a combination of attributes defined by a user.

7. The machine-readable medium of claim 6, wherein the rules are consistent only if a constraint satisfaction problem has no solutions under over-lapping and under-coverage constraints.

8. The machine-readable medium of claim 6, wherein the rules are inconsistent if a constraint satisfaction problem has a solution by instantiations of all attributes when over-lapping or under-coverage constraints are defined.

9. The machine-readable medium of claim 6, wherein operations further comprise telling a user which combinations of attributes cause the rules to be under-covered or over-lapping.

10. The machine-readable medium of claim 6, wherein operations further comprise preventing a user from entering rules that are inconsistent.

11. An apparatus comprising at least one tool to provide for validation of consistency of rules by representing the rules as a constraint satisfaction problem.

12. The apparatus of claim 11, wherein the rules are consistent only if the constraint satisfaction problem has no solutions under over-lapping and under-coverage constraints.

13. The apparatus of claim 11, wherein representing the rules as a constraint satisfaction problem includes:
associating a constrained variable with an attribute of the rules for each attribute; and
defining a constraint on all constrained variables for a combination of attributes, for each combination, defined by a user.

14. The apparatus of claim 13, wherein the rules are inconsistent if the constraint satisfaction problem has a solution by instantiations of all attributes when over-lapping or under-coverage constraints are defined.

15. The apparatus of claim 13, wherein validation includes telling a user which combinations of attributes cause the rules to be under-covered or over-lapping.

16. The apparatus of claim 13, wherein validation includes preventing a user from entering rules that are inconsistent.
